(19) United States
(12) Patent Application Publication
(10) Pub. No.: US 2025/0371789 A1
(43) Pub. Date: Dec. 4, 2025

(54) METHODS FOR GENERATING A SET OF GRAPHICS SHADERS

(71) Applicant: Sony Interactive Entertainment Inc., Tokyo (JP)

(72) Inventors: Jun Yen Leung, London (GB); Patrick John Connor, London (GB); Maria Chiara Monti, London (GB); Lawrence Martin Green, London (GB); Maurizio Cerrato, London (GB); Rajeev Gupta, London (GB)

(21) Appl. No.: 19/218,717

(22) Filed: May 27, 2025

(30) Foreign Application Priority Data
May 28, 2024 (GB) 2407540.0

(51) Int. Cl. G06T 15/00; G06T 15/80

(52) U.S. Cl. CPC G06T 15/005; G06T 15/80

(57) ABSTRACT

Disclosed herein is a computer-implemented method for generating a set of graphics shaders for rendering a required set of graphical components, comprising: providing a first set of graphics shaders, wherein each graphics shader in the first set is configured to render a different graphical component; and combining a plurality of the graphics shaders in the first set to produce a second set of graphics shaders, such that the second set comprises fewer graphics shaders than the first set, wherein the plurality of graphics shaders are combined into the second set such that a measured property of the second set meets a predetermined criterion.

### CROSS-REFERENCE TO RELATED APPLICATIONS

This application claims the benefit of priority of British Application No. GB 2407540.0, filed on May 28, 2024, the entire contents of which is incorporated by reference in its entirety.

### FIELD OF THE INVENTION

The present invention relates to methods for generating a set of graphics shaders. In particular, the present invention relates to computer-implemented methods for generating a set of graphics shaders for rendering a required set of graphical components.

### BACKGROUND

The development of modern video games has seen continuous advances in the complexity and realism of graphics, driven by ongoing improvements in hardware, software and rendering techniques. These advances have enabled graphics developers to create increasingly immersive and visually striking gaming experiences. However, this has also resulted in the increasing implications of a number of challenges in the graphics processing pipeline.

A typical video game requires a large variety of different types of graphical elements and rendering techniques. These are implemented using graphics shader programs run at GPU, which are responsible for the different rendering processes within the graphics rendering pipeline. The huge range of different rendering functions required poses challenges in how best to implement the shaders required to provide the range of processing techniques.

One approach to implementing graphics shaders involves using a larger number of smaller task-specific shaders, that are each responsible for a narrower range of processing tasks, such as rendering a particular material, or lighting effect.

These task-specific shaders may be permutations (or variants) of a single shader, for example.

An issue with using a large number of task-specific shaders is that a huge number of individual shaders are required to render any one particular scene. Depending on the type of video gaming system, these shaders may be required to be compiled at run time or precompiled for use. When they are compiled at run time there can be significant performance impact, as there are delays in rendering while the correct shaders are compiled for use, which can result in stuttering in the gameplay.

Another approach to implementing graphics shaders involves using larger “uber-shaders”, which are able to render lots of different types of data. However, these types of large shader are typically slow to run, particularly when they involve dynamic branches, and they do not make most efficient use of the capacity of the GPU.

There is accordingly a need for a method that overcomes these issues, and provides greater flexibility in the deployment of shaders, allowing a greater range of task specific shaders to be used while minimizing detrimental effects on performance.

### SUMMARY

The present disclosure provides a computer-implemented method for generating a set of graphics shaders for rendering a required set of graphical components, comprising: providing a first set of graphics shaders, wherein each graphics shader in the first set is configured to render a different graphical component (or a plurality of different graphical components); and combining a plurality of the graphics shaders in the first set to produce a second set of graphics shaders, such that the second set comprises fewer graphics shaders than the first set, wherein the plurality of graphics shaders are combined into the second set such that a measured property or measured properties of the second set meets or meet or a predetermined criterion or predetermined criteria.

In this way, at least some graphics shaders in the first set can be combined to produce a number of larger graphics shaders in the second set, thereby reducing the overall number of graphics shaders that need to be compiled. Advantageously, the second set comprises graphics shaders that can be used without overly hindering the performance of the GPU running them, since the combined graphics shaders are not overly large. In other terms, the present disclosure provides an optimal solution in which issues associated with compiling a large number of task-specific shaders and the use of large branched “uber-shaders” are each reduced.

In various embodiments, the first set of graphics shaders may be generated. Alternatively, the first set of graphics shaders may be provided as an off-the-shelf package of shaders. In certain embodiments, each graphics shader in the first set may be combined with at least one other shader in the first set. Alternatively, a portion of the shaders in the first set may not be combined at all.

Preferably, the plurality of graphics shaders are combined into the second set such that a plurality of measured properties of the second set meet respective predetermined criteria. The plurality of measured properties of the second set may include one or more of a number of graphic shaders in the second set, a file size associated with the second set or a time to compile the second set. In this way, the second set can be generated from the first set based on a number of different criteria to optimise the properties of the second set.

In various embodiments, the predetermined criteria are (or the predetermined criterion is) user adjustable or are (is) set by selection of an adjustable parameter (or adjustable parameters). In this way, a user can select properties of the second set based on the rendering task that they need to perform. Alternatively, the properties of the second set can be selected based on performance constraints of the GPU being used to compile the graphics shaders. In particular, the property may be selected based on a determined performance metric of the GPU, for example based on a model of GPU or a measured processing capacity of the GPU.

In various embodiments, the user adjustable predetermined criteria (or criterion) or the adjustable parameter comprise a maximum allowable number of graphic shaders in the second set. In this way, the number of graphics shaders in the second set to compile can be controlled and adjusted. Alternatively, the user adjustable predetermined criteria (or criterion) or the adjustable parameter may comprise a minimum allowable number of graphic shaders in the second set or a range of allowable numbers of graphic shaders in the second set.

In various embodiments, the user adjustable predetermined criteria (or criterion) or the adjustable parameter comprise a maximum allowable file size associated with the second set. In this way, the amount of data to be compiled in relation to the second set of graphics shaders can be controlled and adjusted based on performance limitations or runtime requirements. In alternative embodiments, the user adjustable predetermined criteria (or criterion) or the adjustable parameter may comprise a minimum allowable file size associated with the second set or a range of allowable file sizes associated with the second set.

In various embodiments, the user adjustable predetermined criteria (or criterion) or the adjustable parameter comprise a maximum allowable time to compile the second set. In this way, the required time for the second set of graphics shaders to be compiled can be controlled and adjusted. This may also be based on performance limitations or runtime requirements. In alternative embodiments, the user adjustable predetermined criteria (or criterion) or the adjustable parameter may comprise a minimum time to compile the second set or a range of allowable times to compile the second set.

In various embodiments, the method may further comprise iteratively combining the graphics shaders in the first set and measuring the property of the second set until the measured property meets the predetermined criteria (or criterion). In this way, the graphics shaders in the first set can be combined up until the point at which the predetermined criteria (or criterion) are (or is) satisfied.

In embodiments where the plurality of graphics shaders are combined into the second set such that a measured property of the second set meets a predetermined criterion, the method may further comprise iteratively combining the graphics shaders in the first set and measuring the property of the second set until the measured property meets the predetermined criterion.

In embodiments where the plurality of graphics shaders are combined into the second set such that a plurality of measured properties of the second set meet respective predetermined criteria, the method may further comprise iteratively combining the graphics shaders in the first set and measuring the plurality of properties of the second set until the measured properties meet the respective predetermined criteria.

In various embodiments, the shaders in the first set are combined such that the one or more graphics shaders of the second set are usable to render a plurality of the different graphical components. In this way, the graphics shaders in the second set can be used to produce a variety of different graphical components or rendering effects, such as textures. In various embodiments, each graphical component may comprise one or more of: a different material, lighting effect, animation, or post processing effect.

In various embodiments, combining a plurality of graphics shaders in the first set may comprise: forming a composite shader comprising a branch between alternative functional components, each functional component providing the function of a graphics shader in the first set. Preferably, each of the branches of the combined graphics shaders calculate a different rendering effect.

In this way, the second set may comprise one or more versatile composite shaders (or “uber-shaders”) that are able to render lots of different types of graphical component. The specific type of graphical component that a composite shader may be required to render could be selected at runtime of a video game. In various embodiments, the term “branching” may refer to the ability of a shader program to execute different shader code paths based on conditions evaluated at runtime. In various embodiments, branches are formed by including conditional statements in the computer program code defining respective shaders.

In various embodiments, providing the first set may comprise: generating an initial graphics shader; and generating a plurality of variants of the initial graphics shader. Preferably, the plurality of variants are permutations of the initial graphics shader.

In this way, a large number of task-specific shaders can be generated for use in rendering a variety of graphics effects. In various embodiments, the term “permutations” may refer to different variations or configurations of a graphics shader program that can be generated to support various combinations of graphics effects or GPU hardware capabilities. In various embodiments, forming permutations of an initial shader may comprise duplicating the initial shader and modifying parameters within the duplicated computer program code.

In various embodiments, combining at least a portion of the graphics shaders in the first set may comprise: analysing the graphics shaders in the first set to determine possible combinations of the graphics shaders in the first set. Preferably, analysing the graphics shaders in the first set to determine possible combinations comprises: analysing the graphics shaders in the first set to determine the graphics shaders that are similar to one another.

In this way, graphics shaders in the first sent can be combined based on how similar they are to each other, resulting in a second set of graphics shaders with a more diverse range of rendering capabilities.

For example, in order to determine the similarity between graphics shaders in the first set, a reference image may be rendered with each of the shaders in the first set. From these images, a similarity metric can be calculated between respective shaders based on a comparison of the similarity of the reference image rendered with the respective shaders.

Preferably, determining the graphics shaders that are similar to one another comprises: analysing the graphics shaders in the first set to determine which graphics shaders have similar parameters. For example, parameters of the code defining the graphics shaders can be compared to determine similarities between the shaders. In this way, the most similar shader code can be combined, as having multiple similar shaders in the second set is generally less useful than having multiple diverse shaders.

In various embodiments, combining at least a portion of the graphics shaders in the first set may comprise: combining graphics shaders in the first set that are similar to one another. Graphics shaders may be combined in pairs, in groups of 3, 4, 5 or more.

Preferably, combining graphics shaders that are similar to one another in the first set comprises: initially combining the graphics shaders in the first set that are most similar to one another; and subsequently combining the graphics shaders in the first set that are less similar to one another. In other terms, shaders are progressively combined starting with those that are most similar. In this way, the second set of shaders can comprise diverse shaders that are able to produce a variety of graphical components or rendering effects.

Preferably, combining graphics shaders in the first set that are most similar to one another comprises: combining pairs of graphics shaders in the first set that are most similar to one another. In this way, the composite shaders that are generated by combining the task-specific shaders in the first set are not overly large to the extent that they create detrimental effects on GPU performance.

In various embodiments, combining at least a portion of the graphics shaders in the first set may comprise: combining the at least a portion of the graphics shaders in the first set based on the order in which they would be used at runtime of a video game. It has been found that it is beneficial to avoid having to change shaders often. Therefore, it is advantageous to combine shaders consecutively, in the order in which they would be used at runtime.

In various embodiments, the method may further comprise storing the second set of graphics shaders for use in rendering graphics data of a video game. In various embodiments, the method may further comprise using the second set of graphics shaders for rendering a scene of a video game.

### BRIEF DESCRIPTION OF DRAWINGS

Embodiments of the present disclosure will be described by way of example, by reference to the drawings, in which:

FIG. 1 is a flow diagram of a computer-implemented method for generating a set of graphics shaders for rendering a required set of graphical components in an embodiment of the present disclosure;

FIG. 2A is a flow diagram of a computer-implemented method for generating a set of graphics shaders for rendering a required set of graphical components in another embodiment of the present disclosure; and

FIG. 2B is a flow diagram of an aspect of the computer-implemented method according to FIG. 2A.

### DETAILED DESCRIPTION

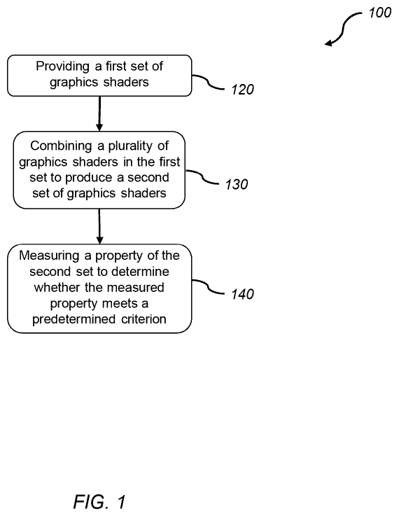

FIG. 1 is a flow diagram of a computer-implemented method 100 for generating a set of graphics shaders for rendering a required set of graphical components in an embodiment of the present disclosure. The method 100 comprises the steps 120, 130 and 140. In particular, step 120 comprises providing a first set of graphics shaders; step 130 comprises combining a plurality of graphics shaders in the first set to produce a second set of graphics shaders; and step 140 comprises measuring a property of the second set to determine whether the measured property meets a predetermined criterion.

At step 120, an “off the shelf” package of graphics shaders is provided which forms a first set. Each of the shaders in the first set are a computer program, with each program configured to render a different graphical component. In the embodiments describe herein, each shader in the first set may calculate different levels of light, darkness and/or color during rendering of a 3D scene of a video game.

At step 130, a plurality of graphics shaders in the first set are combined to produce a second set of graphics shaders. The purpose of this step is to produce a set of graphics shaders that is lesser in number than that of the first set. Combining graphics shaders involves forming larger, composite shaders by combining the computer program code of respective shaders.

At step 140, a property of the second set is measured to determine whether the measured property meets a predetermined criterion. In this embodiment, the property measured is the total number of shaders in the second set and the predetermined criterion is a maximum allowable number of shaders in the second set. If the total number of shaders in the second set meets the predetermined criterion the second set can be deployed to be used in rendering a required set of graphical components.

If, once the shaders in the first set have been combined at step 130, it is determined that the second set comprises a greater number of shaders than allowed by the predetermined criterion, shaders may be further combined to reduce the total number of shaders.

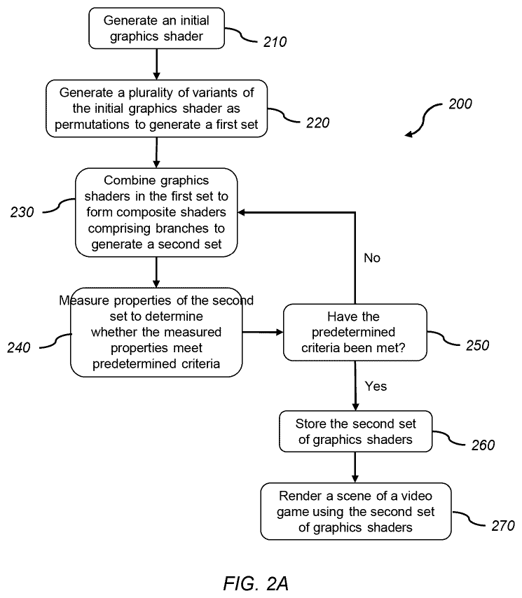

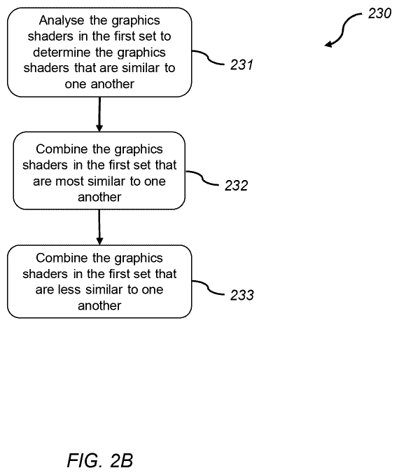

FIG. 2A is a flow diagram of a computer-implemented method 200 for generating a set of graphics shaders for rendering a required set of graphical components in another embodiment of the present disclosure.

The method 200 comprises the steps 210, 220, 230, 240, 250, 260 and 270. In particular, step 210 comprises generating an initial graphics shader; step 220 comprises generating a plurality of variants of the initial graphics shader as permutations to generate a first set of graphics shaders; step 230 comprises combining graphics shaders in the first set to form composite shaders comprising branches to generate a second set of graphics shaders; step 240 comprises measuring properties of the second set to determine whether the measured properties meet predetermined criteria; step 250 comprises determining whether the predetermined criteria have been met; if the predetermined criteria are determined to have not been met, then the method returns to step 230; if the predetermined criteria are determined to have been met, then the method progresses to step 260; step 260 comprises storing the second set of graphics shaders; and step 270 comprises rendering a scene of a video game using the second set of graphics shaders.

To illustrate this embodiment, it will be described with respect to an exemplary graphics shader referred to herein as S1. In this illustrative example, S1 is configured to render a graphical component of an object with a color of PANTONE® 151C at 50% brightness with a saturation of 80%.

At step 210, S1 is generated and it is configured to render a graphical component. The graphical component comprises a material effect (color), a lighting effect (brightness) and a post processing effect (saturation).

At step 220, a plurality of variants of the initial graphics shader S1 are generated as permutations to produce a first set of graphics shaders. Each of the generated shaders, or permutations, in the first set are configured to render a different graphical component to S1. As such, each of the shaders in the first set are uniquely configured to render one or more of a material effect (color), a lighting effect (brightness) and a post processing effect (saturation).

For example, 100 different variations, or permutations, of the initial shader S1 will be generated, each configured to render an object with a color of PANTONE® 151C at a range of different brightnesses and saturations, such as 20% to 80% brightness and 5% to 95% saturation. In this illustrative example, the file size of the first set is 100 kilobytes and has a compile time of 100 milliseconds.

At step 230, the various different graphics shaders in the first set are combined using branches to form composite shaders and thus a second set of shaders. The purpose of this is to produce a second set of graphics shaders that is lesser in number than the first set and to provide a set of shaders that are usable to render a plurality of different graphical components.

The combined composite shaders comprise branches between alternative function components. A single functional component of a composite shader provides the rendering function of a graphics shader in the first set. In other terms, each branch of a composite shader in the second set calculates a unique rendering effect.

In the context of the presented illustrative example, one branch of a composite shader could configured to render an object with a color of PANTONE® 151C at a brightness of 25% and a saturation of 90%, and another branch could be configured to render an object with a color of PANTONE® 151C at a brightness of 75% and a saturation of 70%. These two exemplary branches are each permutations of the initial shader S1.

Additional aspects of step 230 are depicted in the flow diagram of FIG. 2B. In the present embodiment, step 230 comprises the additional sub-steps 231, 232 and 233. In particular, step 231 comprises analysing the graphics shaders in the first set to determine the graphics shaders in the first set that are similar to one another, and those that are less similar to one another; step 232 comprises combining the graphics shaders in the first set that are most similar to one another; then, at step 233, graphics shades in the first set that are less similar to one another are combined.

At step 231, the graphics shaders in the first set are analysed to determine the graphics shaders in the first set that are similar to one another, and those that are less similar to one another. This can be done by either determining which shaders have similar parameters by comparing their respective code, or by rendering a reference image with each of the shaders and comparing these to determine their similarity.

In the latter approach a similarity metric is calculated between respective shaders based on a comparison of the similarity of the reference image rendered with the respective shaders. The shaders are then combined with each other based on the similarity metric. Respective shaders in the first set that are configured to render objects with similar brightness and saturation characteristics may therefore be combined.

At step 232, the pairs of shaders that are deemed to be most similar to each other are first combined to produce composite shaders by forming branches between them as described above. Subsequently, pairs of shaders that are deemed to be less similar to each other are combined also by forming branches between them at step 233.

In an alternative embodiment, a technique to determine which shaders in the first set should be combined comprises analysing the shaders to determine the order in which they would be used at runtime of a video game. The 100 shaders generated at step 220 could therefore be combined so that they are presented in an order in the second set that corresponds to the order in which they would be run to produce the required graphical components.

For example, if a video game being run requires, in order, graphical components A, B, C, and D. The combination of the shaders that are configured to render A and B into one composite shader and C and D into another composite would be more effective than combining A with C and B with D.

Returning to the method of FIG. 2A, at step 240, properties of the combined shaders in the second set are measured to determine whether predetermined criteria are met. The purpose of this step is to ensure that shaders in the first set are combined into the second set such that a plurality of measured properties of the second set meet respective predetermined criteria.

In this embodiment, the predetermined criteria comprise adjustable parameters indicating a maximum allowable number of graphic shaders in the second set, a maximum allowable file size associated with the second set and a maximum allowable time to compile the second set. In this illustrative example, the predetermined criteria comprises a maximum of 50 shaders in the second set, a maximum file size of 50 kilobytes and a maximum time of 500 milliseconds to compile the second set.

At step 250, is determined whether the combination of the shaders in the first set has resulted in a second set of shaders with properties that meet the above predetermined criteria. If the criteria are deemed to have not been met, shaders are further combined in the manner described at step 230. This step of the method ensures that shaders are combined until the properties of the resulting combined shaders meet the predetermined criteria, such as that given above.

Steps 230, 240 and 250 therefore involve iteratively combining graphics shaders in the first set, starting with those that are most similar, and following with those that are less similar to one another, until the measured properties of the combined graphics shaders in the second set meet the predetermined criteria.

As such, based on the predetermined criteria above, the 100 shaders in the first set will be combined until the second set comprises 50 shaders with a total file size reduced from 100 kilobytes to 50 kilobytes and a compile time of 1000 milliseconds reduced to 500 milliseconds.

If the criteria are deemed to have been met in relation to the combined shaders, the second set of shaders are stored in a memory of the device being used to render the graphical components at step 260. In the context of the present method, the memory is that of a video game console.

At step 270, a scene of a video game is rendered using the second set of graphics shaders. The shaders are streamed from the memory of the video game console to a GPU of the console for use at runtime of the video game.

1. A computer-implemented method for generating a set of graphics shaders for rendering a required set of graphical components, comprising:
providing a first set of graphics shaders, wherein each graphics shader in the first set is configured to render a different graphical component; and
combining a plurality of the graphics shaders in the first set to produce a second set of graphics shaders, such that the second set comprises fewer graphics shaders than the first set, and such that a measured property of the second set meets a predetermined criterion.

2. The computer-implemented method according to claim 1, wherein the plurality of graphics shaders in the first set are combined such that a plurality of measured properties of the second set meet respective predetermined criteria.

3. The computer-implemented method according to claim 1, wherein the predetermined criteria are user adjustable or are set by selection of an adjustable parameter.

4. The computer-implemented method according to claim 3, wherein the user adjustable predetermined criteria or the adjustable parameter comprise a maximum allowable number of graphic shaders in the second set.

5. The computer-implemented method according to claim 3, wherein the user adjustable predetermined criteria or the adjustable parameter comprise a maximum allowable file size associated with the second set.

6. The computer-implemented method according to claim 3, wherein the user adjustable predetermined criteria or the adjustable parameter comprise a maximum allowable time to compile the second set.

7. The computer-implemented method according to claim 1, further comprising:
iteratively combining the graphics shaders in the first set and measuring a property of the second set until the measured property meets the predetermined criteria.

8. The computer-implemented method according to claim 1, wherein the graphics shaders in the first set are combined such that the one or more graphics shaders of the second set are usable to render a plurality of the different graphical components.

9. The computer-implemented method according to claim 1, wherein each graphical component comprises one or more of:
a different material, lighting effect, animation or post processing effect.

10. The computer-implemented method according to claim 1, wherein combining the plurality of graphics shaders in the first set comprises:
forming a composite shader comprising a branch between alternative functional components, each functional component providing a function of a graphics shader in the first set.

11. The computer-implemented method according to claim 10, wherein each branch of the combined graphics shaders calculate a different rendering effect.

12. The computer-implemented method according to claim 1, wherein providing the first set comprises:
generating an initial graphics shader; and
generating a plurality of variants of the initial graphics shader.

13. The computer-implemented method according to claim 12, wherein the plurality of variants are permutations of the initial graphics shader.

14. The computer-implemented method according to claim 1, wherein combining at least a portion of the graphics shaders in the first set comprises:
analysing the graphics shaders in the first set to determine possible combinations of the graphics shaders in the first set.

15. The computer-implemented method according to claim 14, wherein analysing the graphics shaders in the first set to determine possible combinations comprises:
analysing the graphics shaders in the first set to determine the graphics shaders that are similar to one another.

16. The computer-implemented method according to claim 15, wherein determining the graphics shaders that are similar to one another comprises:
analysing the graphics shaders in the first set to determine which graphics shaders have similar parameters.

17. The computer-implemented method according to claim 15, wherein combining at least a portion of the graphics shaders in the first set comprises:
combining graphics shaders in the first set that are similar to one another.

18. The computer-implemented method according to claim 17, wherein combining graphics shaders that are similar to one another in the first set comprises:
initially combining the graphics shaders in the first set that are most similar to one another; and
subsequently combining the graphics shaders in the first set that are less similar to one another.

19. The computer-implemented method according to claim 1, wherein combining at least a portion of the graphics shaders in the first set comprises:
combining the at least a portion of the graphics shaders in the first set based on an order in which they would be used at runtime of a video game.

20. The computer-implemented method according claim 1, further comprising:
using the second set of graphics shaders for rendering a scene of a video game.
